(19) United States
(12) Patent Application Publication
(10) Pub. No.: US 2005/0110725 A1
(43) Pub. Date: May 26, 2005

(54) Flat panel display device with triodic rectifier switch

(76) Inventors: Won-Kyu Kwak, Seongnam-si (KR); Min-Chul Suh, Seongnam-si (KR); Won-Pil Lee, Yongin-si (KR); Chang-Su Seo, Suwon-si (KR)

Correspondence Address: MCGUIREWOODS, LLP, 1750 TYSONS BLVD, SUITE 1800, MCLEAN, VA, 22102, US

(21) Appl. No.: 10/995,475

(22) Filed: Nov. 24, 2004

(30) Foreign Application Priority Data
Nov. 26, 2003 (KR) 2003-84747

(51) Int. Cl. H01L 29/04; G09G 3/30

(52) U.S. Cl. 345/76

(57) ABSTRACT

The present invention provides an improved plasma display panel that includes a plurality of data lines for outputting data signals, and a plurality of scan lines for outputting selection signals. Pixels are formed at intersecting portions of the data lines and the scan lines, and each pixel includes a switching device. Each switching device includes a resistor and a plurality of diodes, The switching device is turned on by one or more selection signals outputted from the scan line. When turned on, the switching device switches a data signal delivered by the data line and turns a light emitting device on. The light emitting device is configured by combining a static induction transistor with an organic EL device (OLED).

### CROSS-REFERENCE TO RELATED APPLICATION

This application claims priority of Korean Patent Application No. 2003-0084747, filed Nov. 26, 2003, the disclosure of which is herein incorporated by reference.

### BACKGROUND OF THE INVENTION

1. Field of the Invention

The present invention relates to flat panel display devices generally, and, more particularly, to a flat panel display device with a switching device capable of simplifying a manufacturing process and reducing cost by forming pixels with a light emitting device in which a static induction transistor and an organic electroluminescent (EL) element are combined and to a flat panel display, with a switching device that includes a resistor and a plurality of diodes.

2. Description of the Related Art

Generally, an organic EL display device is a flat panel display device that emits light by electrically exciting a fluorescent organic compound, and is configured to display images by driving N×M organic light emitting cells by currents. Such an organic light emitting cell has a laminated structure of an anode electrode formed Indium Tin Oxide (ITO), an organic thin film, and a cathode electrode formed of a metal film. The organic thin film includes an electron transport layer (ETL), a hole transport layer (HTL), an electron injecting layer (EIL), and a hole injecting layer (HIL) in order to improve luminous efficiency of an emission layer by making the balance of electrons and holes to be excellent.

A method of driving the organic light emitting cell configured as above includes a passive matrix driving method and an active matrix driving method, both of which are thin film transistors (TFTs). In the passive matrix driving method, an anode and a cathode are formed to be perpendicular to each other and lines are selected to drive EL devices. On the other hand, the active matrix driving method is a method that drives the EL devices using TFTs and maintains a data signal in a capacitor.

FIG. 1 shows a pixel circuit of a conventional active matrix organic electroluminescent display device. As shown in FIG. 1, a driving transistor M2 is connected to an organic EL device (OLED) to supply a current for emitting light. The amount of the current in the driving transistor M2 is controlled by a data signal applied via a switching transistor M1. At this time, a capacitor Cₛₜ is connected between the source and the gate of the transistor M2 to maintain the applied data signal during a certain period. A selection signal line Scan is connected to the gate of the transistor M1, and a data line Data is connected to the source of the transistor M1.

The operation of the pixel with such a structure will be discussed. If the switching transistor M1 is turned on by the selection signal Scan applied to the gate of the transistor M1, the data signal Data is applied to the gate of the driving transistor M2 via the data line. The current, which corresponds to the data signal Data applied to the gate, flows into the organic EL device OLED via the transistor M2 so that light is emitted.

Illustratively, the current flowing through the organic EL device is represented by the following Equation 1.

$${I}_{OLED} = \frac{β}{2} {( {V}_{gs} - \vert {V}_{th} \vert )}^{2} = \frac{β}{2} {( {V}_{dd} - {V}_{data} - \vert {V}_{th} \vert )}^{2} \qquad Equation 1$$

where, I_{OLED} is the current flowing through the organic EL device, V_{gs} is a voltage across the source and the gate of the transistor M2, Vₜₕ is a threshold voltage of the transistor M2, data is a data signal, and β is a constant value.

As represented in Equation 1, in the pixel circuit shown in FIG. 1, the current corresponding to the applied data signal Data is supplied to the organic EL device OLED, and the organic EL device emits the light corresponding to the supplied current.

However, there is a problem with such a conventional pixel driving circuit in that a process of manufacturing the organic EL device and the thin film transistors are complicated, and accordingly cost increases and yield is limited.

### SUMMARY OF THE INVENTION

The present invention is conceived to solve the aforementioned problem, and various embodiments thereof provide a flat panel display device that uses a triodic rectifier switch capable of being manufactured with low cost by substituting an organic light emitting transistor for an organic light emitting diode and by substituting diodes and a resistor for a thin film transistor, in a light emitting device for emitting each color of light and a driving circuit therefor.

According to the present invention, there is provided a flat panel display device that includes a plurality of data lines for outputting data signals, a plurality of scan lines for outputting selection signals, and a plurality of pixels formed at intersecting portions of the data lines and the scan lines. In one embodiment, each of the pixels includes a switching device, and each switching device includes a resistor and a plurality of diodes. The switching device is turned on by a selection signal outputted from the scan line to switch the data signal delivered by the data line and to turn on a light emitting device.

Illustratively, the light emitting device is configured using a combination of a static induction transistor and an organic EL device (OLED).

In addition, the flat panel display device has a switching device that includes a first diode having a first electrode connected to the data line; a second diode having a second electrode connected to a second electrode of the first diode; a resistor connected between the scan line and a common point of the first and second diodes; and a third diode having a second electrode connected between a first electrode of the second diode and a gate of the light emitting device.

The pixel further includes a capacitive element connected between the first electrode of the second diode and a power supply voltage; and an initialization line connected to a first electrode of the third diode for delivering an initializing signal.

The initialization line transmits the initializing signal in which the transmitted initializing signal is pre-charged in the capacitive element via the third diode.

The light emitting device has a first electrode connected to the first electrode of the second diode, a second electrode connected to a power supply, and a third electrode connected to a cathode voltage.

When the pixel are configured as described above, the flat panel display device operates such that when a predetermined selection signal is applied, a predetermined power supply is stored in the capacitive element by a voltage applied to the capacitive element via the resistor and the second diode.

Further, the above described pixel configuration is such that the voltage stored in the capacitive element is adjusted in size depending on the data signal applied via the first diode.

In addition, the switching device includes a first diode having a second electrode connected to the data line; a second diode having a first electrode connected to a first electrode of the first diode; a resistor connected between a common point of the first and second diodes and the scan line; and a third diode having a first electrode connected between a second electrode of the second diode and a gate of the light emitting device.

In this embodiment the pixel further includes a capacitive element connected between the second electrode of the second diode and a power supply; and an initialization line connected to a second electrode of the third diode for delivering an initializing signal.

As in other embodiments, the flat panel display device has a pixel configured such that a voltage stored in the capacitive element is adjusted in size as the data signal applied via the first diode is adjusted.

Alternatively, there is provided a flat panel display device that includes a plurality of data lines for outputting data signals, a plurality of scan lines for outputting selection signals, and a plurality of pixels formed at intersecting portions between the data lines and the scan lines. Each of the pixels includes a switching device and a capacitive element. The switching device has a resistor and a plurality of diodes connected to the data line and the scan line, respectively. Additionally the pixel is configured such that a specific voltage is stored in the capacitive element by a switching operation of the switching device. Further, the stored voltage is switched and applied by the switching device so that a driving power supply for a light emitting device is generated.

In one embodiment, the switching device includes a first diode having a first electrode connected to the data line; a second diode having a second electrode connected to a second electrode of the first diode; a resistor connected between the scan line and a common point of the first and second diodes; and a third diode having a second electrode connected between a first electrode of the second diode and a gate of the light emitting device.

The pixel further includes a capacitive element connected between the first electrode of the second diode and a power supply voltage; and an initialization line connected to a first electrode of the third diode for delivering an initializing signal.

The flat panel display device may have a light emitting device that is an organic light emitting transistor (OLET) in which a static induction transistor and an organic EL device (OLED) are combined.

In another embodiment the flat panel display device includes a plurality of data lines for outputting data signals, a plurality of scan lines for outputting selection signals, and a plurality of pixels formed at intersecting portions of the data lines and the scan lines. Each of the pixels includes a switching device and a capacitive element. The switching device has a resistor and a plurality of diodes connected to the data line and the scan line, respectively, and the pixel is configured such that a predetermined voltage is stored in the capacitive element by a switching is operation of the switching device so that a driving power supply for a light emitting device is generated.

In addition, the switching device includes a first diode having a second electrode connected to the data line; a second diode having a first electrode connected to a first electrode of the first diode; a resistor connected between a common point of the first and second diodes and the scan line; and a third diode having a first electrode connected between a second electrode of the second diode and a gate of the light emitting device.

In this embodiment, the pixel further includes a capacitive element connected between the second electrode of the second diode and a power supply; and an initialization line connected to a second electrode of the third diode for delivering an initializing signal.

Thus, the flat panel display device is configured such that where a predetermined selection signal is applied, a corresponding predetermined voltage is stored in the capacitive element via the resistor and the second diode.

Additionally, the pixel is configured such that the voltage stored in the capacitive element is adjusted in size as the data signal applied via the first diode is adjusted.

In this embodiment, the light emitting device is an organic light emitting transistor (OLET) in which a static induction transistor and an organic EL device (OLED) are combined.

In yet another embodiment, a flat panel display device includes a plurality of data lines for outputting data signals, a plurality of scan lines for outputting selection signals, and a plurality of pixels formed at intersecting portions of the data lines and the scan lines. In this embodiments each of the pixels includes a first diode having a first electrode connected to the data line; a second diode having a second electrode connected to a second electrode of the first diode; a resistor connected between the scan line and a common point of the first and second diodes; a light emitting device connected to a first electrode of the second diode; a third diode having a second electrode connected between a first electrode of the second diode and a gate of the light emitting device; a capacitive element connected between the first electrode of the second diode and a power supply voltage; and an initialization line connected to a first electrode of the third diode for delivering an initializing signal.

In this embodiment, the flat panel display device may include a the light emitting device configured by a combination of a static induction transistor and an organic EL device (OLED).

Alternatively, an organic electroluminescent display device is provided that includes a plurality of data lines for outputting data signals, a plurality of scan lines for outputting selection signals, and a plurality of pixels formed at intersecting portions of the data lines and the scan lines. In this embodiment, each of the pixels includes a first diode having a second electrode connected to the data line; a second diode connected to a first electrode of the first diode; a resistor connected between a common point of the first and second diodes and the scan line; a light emitting device having a gate connected to a second electrode of the second diode; a third diode having a first electrode connected between a first electrode of the second diode and a gate of the light emitting device; a capacitive element connected between the second electrode of the second diode and a power supply; and an initialization line connected to a second electrode of the third diode for delivering an initializing signal.

In this embodiment, the organic electroluminescent display device may include a the light emitting device configured by a combination of a static induction transistor and an organic EL device (OLED).

### BRIEF DESCRIPTION OF THE DRAWINGS

The above and other features and advantages of the present invention will become more apparent to those of ordinary skill in the art by describing in detail preferred embodiments thereof with reference to the attached drawings.

FIG. 1 is a circuit diagram illustrating a pixel circuit of a conventional organic electroluminescence display device.

FIG. 2 is a circuit diagram of a display device with a triodic rectifier switch according to a first embodiment of the present invention.

FIG. 3 is a timing diagram of a display device with a triodic rectifier switch according to a first embodiment of the present invention.

FIG. 4 is a circuit diagram of a display device with a triodic rectifier switch according to a second embodiment of the present invention.

FIG. 5 is a timing diagram of a display device with a triodic rectifier switch according to a second embodiment of the present invention.

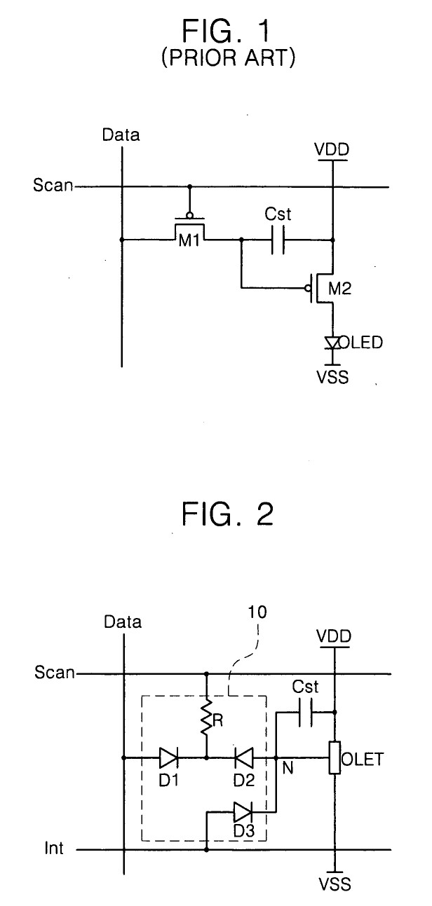

### DETAILED DESCRIPTION OF THE INVENTION

The present invention will now be described more fully hereinafter with reference to the accompanying drawings, in which preferred embodiments of the invention are shown. This invention may, however, be embodied in different forms and should not be construed as limited to the embodiments set forth herein. Rather, these embodiments are provided so that this disclosure will be thorough and complete, and will fully convey the scope of the invention to those skilled in the art. In the drawings, the thickness of layers and regions are exaggerated for clarity. Like numbers refer to like elements throughout the specification.

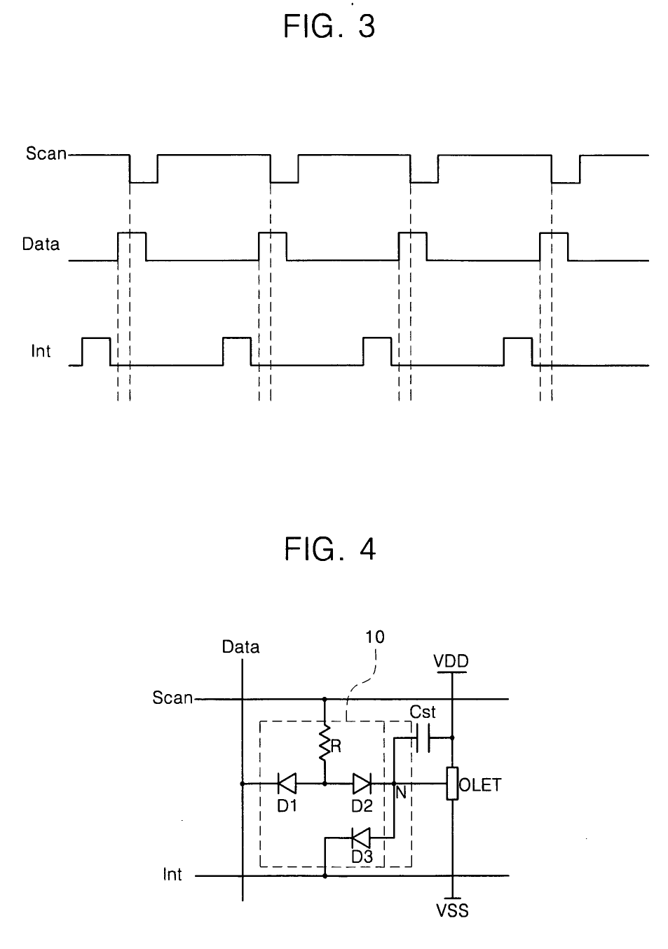

FIG. 2 is a circuit diagram illustrating a first embodiment of the present invention and FIG. 3 is a timing diagram of the first embodiment.

Referring to FIG. 2, a pixel circuit of the flat panel display device according to the first embodiment of the present invention is composed of a triodic rectifier switch 10 connected to a scan line and a data line, and to a storage capacitor Cₛₜ that stores a data signal delivered by a switching operation of the triodic rectifier switch 10. The flat panel device also includes an organic light emitting transistor (OLET) for emitting light based on the data signal stored in the storage capacitor Cₛₜ.

Specifically, the triodic rectifier switch 10 is composed of three diodes and a resistor. A first diode D1 has an anode connected to the data line and a cathode connected to a cathode of a second diode D2. One side of the resistor R is connected between the cathode of the first diode D1 and the cathode of the second diode D2, and the other side is connected to the scan line Scan. In addition, a gate of the organic light emitting transistor OLET is connected to an anode of the second diode D2, a power supply (VDD) is coupled to the source of the organic light emitting transistor OLET, and a cathode voltage VSS is coupled to the drain of the organic light emitting transistor. In addition, an anode of a third diode D3 is connected to an initialization line Iₙₜ, and a cathode of the third diode D3 is connected between the gate of the organic light emitting transistor OLET and the anode of the second diode D2.

The organic light emitting transistor OLET may be an organic light emitting transistor (OLET) formed by combining a static induction transistor and an organic EL device (OLED). The organic light emitting transistor (OLET) has a combined structure of the organic EL device (OLED) and the static induction transistor (SIT) in which a grid type thin metal as an intermediate layer serves as its gate. Unlike a TFT, an organic EL layer is formed on the grid type intermediate layer, resulting in a vertical structure. A channel between the source and the drain of the transistor has such a small length that a driving speed is fast. The driving may be made using a low voltage, and a manufacturing process is simple as compared to a conventional organic EL device (OLED).

The operation of the first embodiment of the present invention having the above-stated configuration will be discussed in detail in connection with a timing diagram of FIG. 3.

First, when a high signal is applied via the initialization line Iₙₜ, the third diode D3 of the triodic rectifier switch 10 is conducted to deliver an initializing signal to the storage capacitor Cₛₜ, such that a pre-charging voltage is charged in the storage capacitor Cₛₜ.

If a low selection signal over the scan line Scan is applied via the resistor R and a data signal is applied via the data line Data after a certain time has elapsed, the voltage stored in the storage capacitor Cₛₜ is discharged through the second diode D2 and the resistor R. In addition, as the data signal is applied to the anode of the first diode D1, the current in the storage capacitor Cₛₜ discharged through the resistor R and the second diode D2 is limited in size. That is, the voltage stored in the storage capacitor Cₛₜ is adjusted depending on the size of the data voltage delivered via the first diode D1.

Specifically, if the data signal is a high voltage having a constant size, the amount of charges discharged via the resistor R and the second diode D2 lessens. Accordingly the voltage stored in the storage capacitor Cₛₜ becomes larger. Alternatively, if the data voltage becomes smaller, the amount of charges discharged through the resistor R and the second diode D2 increase. Accordingly the voltage of the storage capacitor Cₛₜ becomes lower.

Thus, since the size of the charge voltage in the capacitor is adjusted depending on the size of the data signal as described above, it is preferable that in the first embodiment of the present invention, if the data signal is 3V for example, the pre-charge voltage is charged to a high voltage of 4V or more. Therefore, as the high voltage of 4V or more is charged in the storage capacitor Cₛₜ, a voltage of a constant size is discharged by the data signal and thus a predetermined gate voltage is created at a node N.

In this manner, the gate voltage of the organic light emitting transistor OLET becomes a voltage at the node N. Also, the node voltage becomes a predetermined voltage depending on voltages at the second diode D2, the storage capacitor Cₛₜ and the third diode D3. The node voltage is applied to the gate of the organic light emitting transistor OLET, such that the organic EL device OLED emits the light. That is, in the first embodiment of the present invention, the gate voltage of the organic light emitting transistor OLET is controlled by adjusting the size of the voltage stored in the storage capacitor Cₛₜ, using the data voltage, such that the light is emitted with predetermined colors.

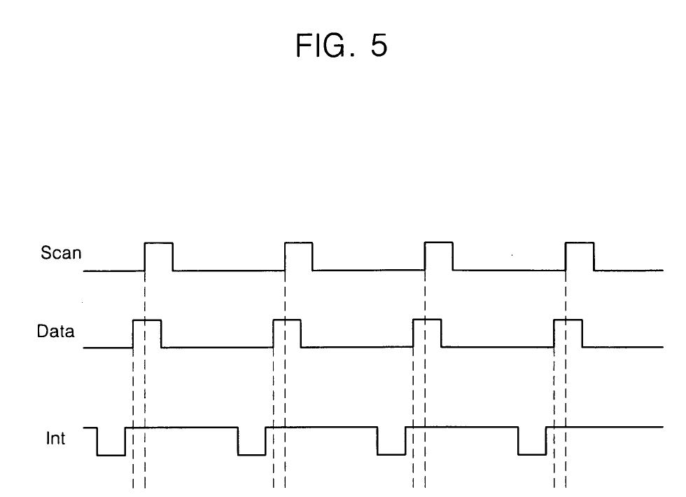

FIG. 4 is a circuit diagram illustrating a second embodiment of the present invention and FIG. 5 is a timing diagram of the second embodiment.

Referring to FIG. 4, a pixel circuit according to the second embodiment of the present invention includes of a triodic rectifier switch 10 each connected to a data line Data, a scan line Scan and an initialization line Iₙₜ, a storage capacitor Cₛₜ for connecting a power supply VDD to a gate of an organic light emitting transistor OLET, and an organic light emitting transistor OLET having a source connected to the power supply VDD and a drain connected to a cathode voltage VSS.

The detailed configuration of the triodic rectifier switch 10 will be discussed herein. The triodic rectifier switch 10 includes a first diode D1 having a cathode connected to is the data line Data, a second diode D2 having an anode connected to an anode of the first diode D1 and a cathode connected to the gate of the organic light emitting transistor OLET, a resistor R connected between the anodes of the first and second diodes D1 and D2 and the scan line Scan, and a third diode D3 having an anode connected between the second diode D2 and the gate of the organic light emitting transistor OLET and a cathode connected to an initialization line Iₙₜ. That is, according to the second embodiment of the present invention, the diodes D1, D2, and D3 of the triodic rectifier switch 10 are arranged with polarities opposite to those of the first embodiment.

The operation of the forgoing configuration according to the second embodiment will be described in detail in connection with a timing diagram of FIG. 5.

First, when a low signal is applied via the initialization line Iₙₜ, the power supply VDD is applied and pre-charges the storage capacitor Cₛₜ. Thereafter, if a high signal is applied via the scan line Scan, a predetermined voltage is stored in the storage capacitor Cₛₜ via the resistor R and the second diode D2. In addition, as the data signal delivered from the data line Data is applied to the first diode D1, the voltage charged in the storage capacitor Cₛₜ via the resistor R and the second diode D2 is limited in size.

That is, in the above-stated first embodiment, the organic light emitting transistor OLET is driven by charging a high voltage in the storage capacitor Cₛₜ and adjusting the size of the discharged voltage using the data signal. In the second embodiment, the driving power supply of the organic light emitting transistor OLET is controlled by charging a low voltage in the storage capacitor Cₛₜ and adjusting the size of the voltage stored in the storage capacitor Cₛₜ using the data signal. Thus, it is preferable that, in the second embodiment of the present invention, the voltage stored in the storage capacitor Cₛₜ is charged to a low voltage of about −4 V or less in the pre-charging step.

The organic light emitting transistor OLET, therefore, emits the light in response to a predetermined driving power supply, which is applied to the node N depending on voltages across the second diode D2, the storage capacitor Cₛₜ, the third diode D3, and respective internal resistances and elements of the organic light emitting transistor OLET.

In one embodiment, the flat panel display device described and used by the above embodiments is an organic electroluminescent display device.

As described above, the present invention implements predetermined colors with a triodic rectifier switch, which includes a plurality of diodes and a resistor, and an organic light emitting transistor, which allows a plasma display panel to be manufactured using in a simple process to reduce manufacturing cost and improve yield.

The drawings and the detailed description are intended only for illustrating the present invention, and are used for explaining the present invention and are not used for limiting what is meant and limiting the scope of the present invention defined in the claims. Therefore, it will be understood by those skilled in the art that a variety of modified and equivalent embodiments are possible from the illustrations. Accordingly, the scope of the present invention should be determined by the the invention defined in the appended claims.

1. A flat panel display device, comprising:
a plurality of data lines for outputting data signals;
a plurality of scan lines for outputting selection signals;
and a plurality of pixels connected to the data lines and the scan lines;
wherein each of the pixels includes a switching device; and
wherein the switching device includes a resistor a plurality of diodes,
wherein the switching device is turned on by one or more of the selection signals outputted from the scan line to switch the data signal delivered by the data line and turn on a light emitting device.

2. The flat panel display device of claim 1, wherein the light emitting device includes a combined static induction transistor and an organic EL device (OLED).

3. The flat panel display device of claim 1, wherein the switching device includes:
a first diode having a first electrode connected to the data line;
a second diode having a second electrode connected to a second electrode of the first diode;
a resistor connected between the scan line and a common point of the first and second diodes; and
a third diode having a second electrode connected between a first electrode of the second diode and a gate of the light emitting device.

4. The flat panel display device of claim 3, wherein the pixel further includes:
a capacitive element connected between the first electrode of the second diode and a power supply voltage; and
an initialization line connected to a first electrode of the third diode for delivering an initializing signal.

5. The flat panel display device of claim 4, wherein the initialization line transmits the initializing signal in which the transmitted initializing signal is pre-charged in the capacitive element via the third diode.

6. The flat panel display device according to claim 3, wherein the light emitting device has a first electrode connected to the first electrode of the second diode, a second electrode connected to a power supply, and a third electrode connected to a cathode voltage.

7. The flat panel display device of claim 3, wherein, when a predetermined selection signal is applied, a predetermined power supply is stored in the capacitive element by applying the voltage to the capacitive element via the resistor and the second diode.

8. The flat panel display device of claim 7, wherein the pixel is such that the voltage stored in the capacitive element is adjusted in size depending on the data signal applied via the first diode.

9. The flat panel display device of claim 1, wherein the switching device includes:
a first diode having a second electrode connected to the data line;
a second diode having a first electrode connected to a first electrode of the first diode;
a resistor connected between a common point of the first and second diodes and the scan line; and
a third diode having a first electrode connected between a second electrode of the second diode and a gate of the light emitting device.

10. The flat panel display device of claim 9, wherein the pixel further includes:
a capacitive element connected between the second electrode of the second diode and a power supply; and
an initialization line connected to a second electrode of the third diode for delivering an initializing signal.

11. The flat panel display device of claim 9, wherein the pixel is such that the voltage stored in the capacitive element is adjusted in size as the data signal applied via the first diode is adjusted.

12. A flat panel display device, comprising:
a plurality of data lines for outputting data signals;
a plurality of scan lines for outputting selection signals; and
a plurality of pixels formed at intersecting portions between the data lines and the scan lines:
wherein each of the pixels includes a switching device and a capacitive element, the switching device has a resistor connected to the data line and a plurality of diodes connected to the scan line, respectively;
wherein the pixel is configured such that a specific voltage is stored in the capacitive element by a switching operation of the switching device, wherein the stored voltage is switched and applied by the switching device so that a driving power supply for a light emitting device is generated.

13. The flat panel display device of claim 12, wherein the switching device includes:
a first diode having a first electrode connected to the data line;
a second diode having a second electrode connected to a second electrode of the first diode;
a resistor connected between the scan line and a common point of the first and second diodes; and
a third diode having a second electrode connected between a first electrode of the second diode and a gate of the light emitting device.

14. The flat panel display device of claim 13, wherein the pixel further includes:
a capacitive element connected between the first electrode of the second diode and a power supply voltage; and
an initialization line connected to a first electrode of the third diode for delivering an initializing signal.

15. The flat panel display device of claim 12, wherein the light emitting device is an organic light emitting transistor (OLET) in which a static induction transistor and an organic EL device (OLED) are combined.

16. A flat panel display device, comprising:
a plurality of data lines for outputting data signals, a plurality of scan lines for outputting selection signals; and
a plurality of pixels connected to the data lines and the scan lines,
wherein each of the pixels includes a switching device and a capacitive element, the switching device having a resistor connected to the data line and a plurality of diodes connected to the scan line, respectively, and
wherein the pixel is configured such that a predetermined voltage is stored in the capacitive element by a switching operation of the switching device so that a driving power supply for a light emitting device is generated.

17. The flat panel display device according to claim 16, wherein the switching device includes:
a first diode having a second electrode connected to the data line;
a second diode having a first electrode connected to a first electrode of the first diode;
a resistor connected between a common point of the first and second diodes and the scan line; and
a third diode having a first electrode connected between a second electrode of the second diode and a gate of the light emitting device.

18. The flat panel display device of claim 16, wherein the pixel further includes:
a capacitive element connected between the second electrode of the second diode and a power supply; and
an initialization line connected to a second electrode of the third diode for delivering an initializing signal.

19. The flat panel display device of claim 16, wherein when a predetermined selection signal is applied, a predetermined voltage is stored in the capacitive element via the resistor and the second diode.

20. The flat panel display device of claim 16, wherein the pixel is such that the voltage stored in the capacitive element is adjusted in size as the data signal applied via the first diode is adjusted.

21. The flat panel display device of claim 16, wherein the light emitting device is an organic light emitting transistor (OLET) in which a static induction transistor and an organic EL device (OLED) are combined.

22. A flat panel display device, comprising:
a plurality of data lines for outputting data signals:
a plurality of scan lines for outputting selection signals;
and a plurality of pixels connected to the data lines and the scan lines, wherein each of the pixels includes:
a first diode having a first electrode connected to the data line;
a second diode having a second electrode connected to a second electrode of the first diode;
a resistor connected between one of the plurality of scan lines and a common point of the first and second diodes;
a light emitting device connected to a first electrode of the second diode;
a third diode having a second electrode connected between a first electrode of the second diode and a gate of the light emitting device;
a capacitive element connected between the first electrode of the second diode and a power supply voltage; and
an initialization line connected to a first electrode of the third diode for delivering an initializing signal.

23. The flat panel display device of claim 22, wherein the light emitting device is configured by a combination of a static induction transistor and an organic EL device (OLED).

24. An organic electroluminescent display device, comprising:
a plurality of data lines for outputting data signals;
a plurality of scan lines for outputting selection signals, and a plurality of pixels connected to the data lines and the scan lines, wherein each of the pixels includes:
a first diode having a second electrode connected to the data line;
a second diode connected to a first electrode of the first diode;
a resistor connected between a common point of the first and second diodes and at least one of the plurality of the scan lines;
a light emitting device having a gate connected to a second electrode of the second diode;
a third diode having a first electrode connected between the second electrode of the second diode and a gate of the light emitting device;
a capacitive element connected between the second electrode of the second diode and a power supply; and
an initialization line connected to a second electrode of the third diode for delivering an initializing signal.

25. The organic electroluminescent display device of claim 24, wherein the light emitting device is configured by a combination of a static induction transistor and an organic EL device (OLED).
